(19) United States
(12) Patent Application Publication
(10) Pub. No.: US 2004/0108661 A1
(43) Pub. Date: Jun. 10, 2004

(54) SEALING STRIP AND A COMPONENT COMPRISING A FIRST AND A SECOND PART AND A SEALING STRIP

(75) Inventor: Ulf STEFANSSON, Skovde (SE)

Correspondence Address: HOWREY SIMON ARNOLD & WHITE LLP, 1299 PENNSYLVANIA AVE., NW, BOX 34, WASHINGTON, DC, 20004, US

(73) Assignee: VOLVO LASTVAGNAR AB, Goteborg (SE)

(21) Appl. No.: 10/604,336

(22) Filed: Jul. 11, 2003

Related U.S. Application Data
(63) Continuation of application No. PCT/SE02/00039, filed on Jan. 11, 2002.

(30) Foreign Application Priority Data
Jan. 12, 2001 (SE) 0100087-6

(51) Int. Cl. F16J 15/02

(52) U.S. Cl. 277/641; 277/637; 277/630

(57) ABSTRACT

Sealing strip made of a substantially incompressible material for sealing between a first and a second component part which have been joined together. The sealing strip is intended to be inserted into a groove present on the first component part, where the sealing strip exhibits a substantially constant width along the main portion of its length and at least one protrusion on the sealing strip. The sealing strip in this portion is intended to be pinched into the groove.

### CROSS REFERENCE TO RELATED APPLICATIONS

This application is a continuation patent application of International Application No. PCT/SE02/00039 filed Jan. 11, 2002 which was published in English pursuant to Article 21(2) of the Patent Cooperation Treaty, and which claims priority to Swedish Application No. 0100087-6 filed Jan. 12, 2001. Both applications are expressly incorporated herein by reference in their entireties.

### BACKGROUND OF INVENTION

1. Technical Field

The present invention relates to a sealing strip for sealing between two joined component parts. Especially, the invention relates to a sealing strip which, by means of clamping force, is to be fitted into a groove for retaining the sealing strip before joining the component parts together in order to form a tight joint. Furthermore, the invention particularly relates to a sealing strip for creating a liquid or gas-impermeable joint between two components. The invention also relates to a component consisting of two component parts, wherein at least one of the component parts exhibits a groove in which a sealing strip is installed in order to form a tight joint between the component parts.

### TECHNICAL BACKGROUND

Typically, when sealing between component parts of a component, particularly when seals between covers and housings which are intended to accommodate a liquid such as water or oil are concerned, a groove is formed in one of the component parts and a sealing strip is fitted into the groove. In order to provide a good sealing action, the sealing strip should have a height which exceeds the depth of the groove. When the component parts are joined together, the sealing strip is compressed between the component parts and a sealing is created. The sealing strip should be substantially incompressible in order to provide good sealing action. Furthermore, the sealing strip should abut against the respective component parts with a substantially constant pressure along the sealing joint. For this reason, it is important that the height of the seal exceeds the depth of the groove with a constant measure along the sealing joint. This means that the seal will abut against the respective component part with a substantially constant pressure when joining the component parts together in order to form a tight joint. In order to achieve a good sealing action, it is further of importance that the sealing strip is correctly positioned in the longitudinal direction of the groove. A common way of installing seals is to position the seal in a groove by hand, and to try to achieve a continuous stretching of the sealing strip while installing it. If there is variation of the tensional force in the sealing strip, also the cross-sectional dimensions of the sealing strip will vary as a result the varying compressibility of the sealing strip. This in turn results in variation of the pressure along the sealing joint, and that a less tight joint will be created. The sealing strip can be designed with protrusions in order to ensure that the clamping force is as constant as possible, and also in order to facilitate the installation of sealing strips in grooves which are directed downwards and where the sealing strip is at risks of falling out. One problem with this type of sealing strip is that the height of the sealing strip will increase when the protrusion is compressed, since the sealing strip is substantially incompressible. As discussed above, this means that the pressure along the sealing joint will vary, and that a less tight joint is created.

### SUMMARY OF INVENTION

One object of the invention is to provide a sealing strip which exhibits protrusions for facilitating installation, wherein the change of height of the sealing strip at the protrusion when pinching the strip in a groove is reduced, and thereby a tighter seal is created. This object is achieved by means of a sealing strip made of a substantially incompressible material, for sealing between a first and a second component part which have been joined together. The sealing strip is adapted to be inserted into a groove present on the first component part, and the sealing strip exhibits a substantially constant width along the main portion of its length. The strip has least one protrusion and the sealing strip is intended to be pinched into the groove at this portion.

The protrusion exhibits a recess configured to be at least partially compressed by said pinching. As a result of the protrusion exhibiting a recess which is intended to be at least partially compressed by said pinching, a clamping force is obtained when compressing the protrusion at the same time as the recess provides space for the incompressible material. In this manner, the change of height of the sealing strip is reduced and a tighter joint can be accomplished.

A further object of the invention is to provide a component including a first and a second component part, and a sealing strip which is adapted to be inserted into a groove present on the first component part, wherein the risk of change of height of the sealing strip occurring at the protrusion when pinching the strip into a groove is reduced. This object is also achieved by inclusion of the recess.

### BRIEF DESCRIPTION OF DRAWINGS

In the following, embodiments of the invention will be described in detail with reference to the attached figures in the drawings, in which:

FIG. 1 shows a top view of a portion of a sealing strip having a protrusion;

FIG. 2 shows the cross-section of the sealing strip and the protrusion at the partition 2-2 in FIG. 1 in accordance with one embodiment of the invention;

FIG. 3 shows the cross-section of a sealing strip taken at a location corresponding to 2-2, but in accordance with a second embodiment of the invention;

FIG. 4 shows the cross-section of a sealing strip taken at a location corresponding to 2-2, but in accordance with a third embodiment of the invention;

FIG. 5 shows the cross-section of a sealing strip taken at a location corresponding to 2-2, but in accordance with a fourth embodiment of the invention;

FIG. 6 is a perspective view of a component part which exhibits a groove for fastening a sealing strip, wherein the groove is designed with a longitudinal extension which varies in three dimensions;

FIG. 7 shows a sealing strip having two successive protrusions; and

FIG. 8 shows a perspective view of an embodiment of a sealing strip having a protrusion.

### DETAILED DESCRIPTION

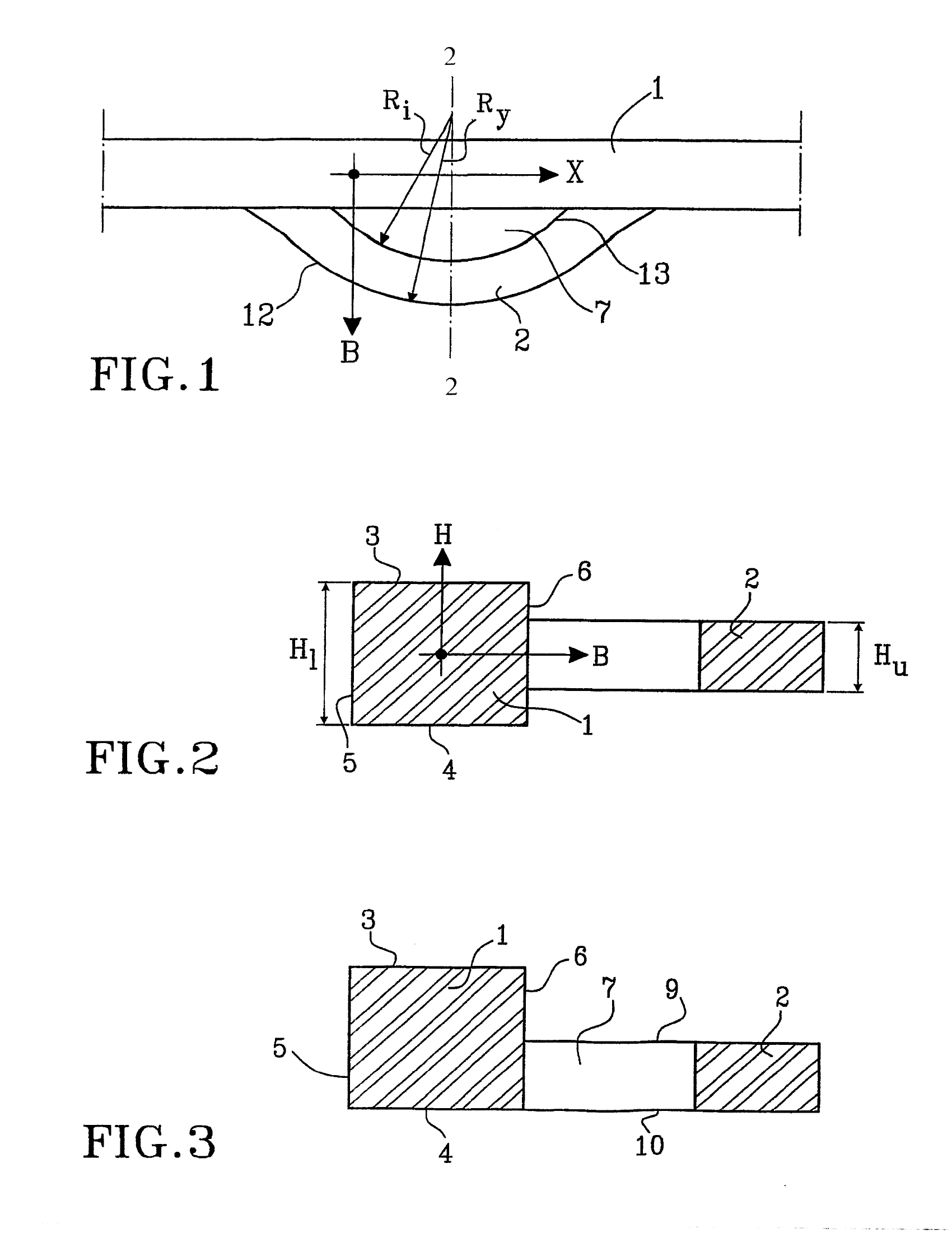

FIG. 1 shows a sealing strip 1 having a protrusion 2. The sealing strip 1 can be designed with a cross-section of any shape, but exhibits an upper delimitation surface 3 intended to abut against a second component part (not shown) included in a component in order to form a tight joint, and a lower delimitation surface 4 intended to abut against a bottom surface in a groove (not shown) formed in a first component part of said component. In the embodiments shown in FIGS. 2-4, the sealing strip 1 is designed with a substantially rectangular cross-section, whereas the cross-section is circular in the embodiment shown in FIG. 5. Furthermore, the sealing strip exhibits a first and a second side surface 5, 6. The upper delimitation surface 3, the lower delimitation surface 4, and the first and the second side surfaces together form the outer delimitation surfaces of the sealing strip. This means that the side surfaces and the upper and lower delimitation surfaces can be optionally configured in order to form, for example, a circular, rectangular, hexagonal, or any other cross-sectional shape. Accordingly, the interpretation of the expression “surface” should not be limited to a planar surface, but also curved surfaces are included. In a preferred embodiment of the invention, the cross-section is designed with substantially planar upper and lower delimitation surfaces. In a further preferred embodiment, the cross-section is designed with a substantially rectangular shape.

Furthermore, the protrusion 2 is designed with a recess 7. In the embodiments shown in FIGS. 2, 3 and 5, the recess is designed as a lead-through. In these cases, the lead-through extends in a direction between the upper delimitation surface 3 and the lower delimitation surface 4.

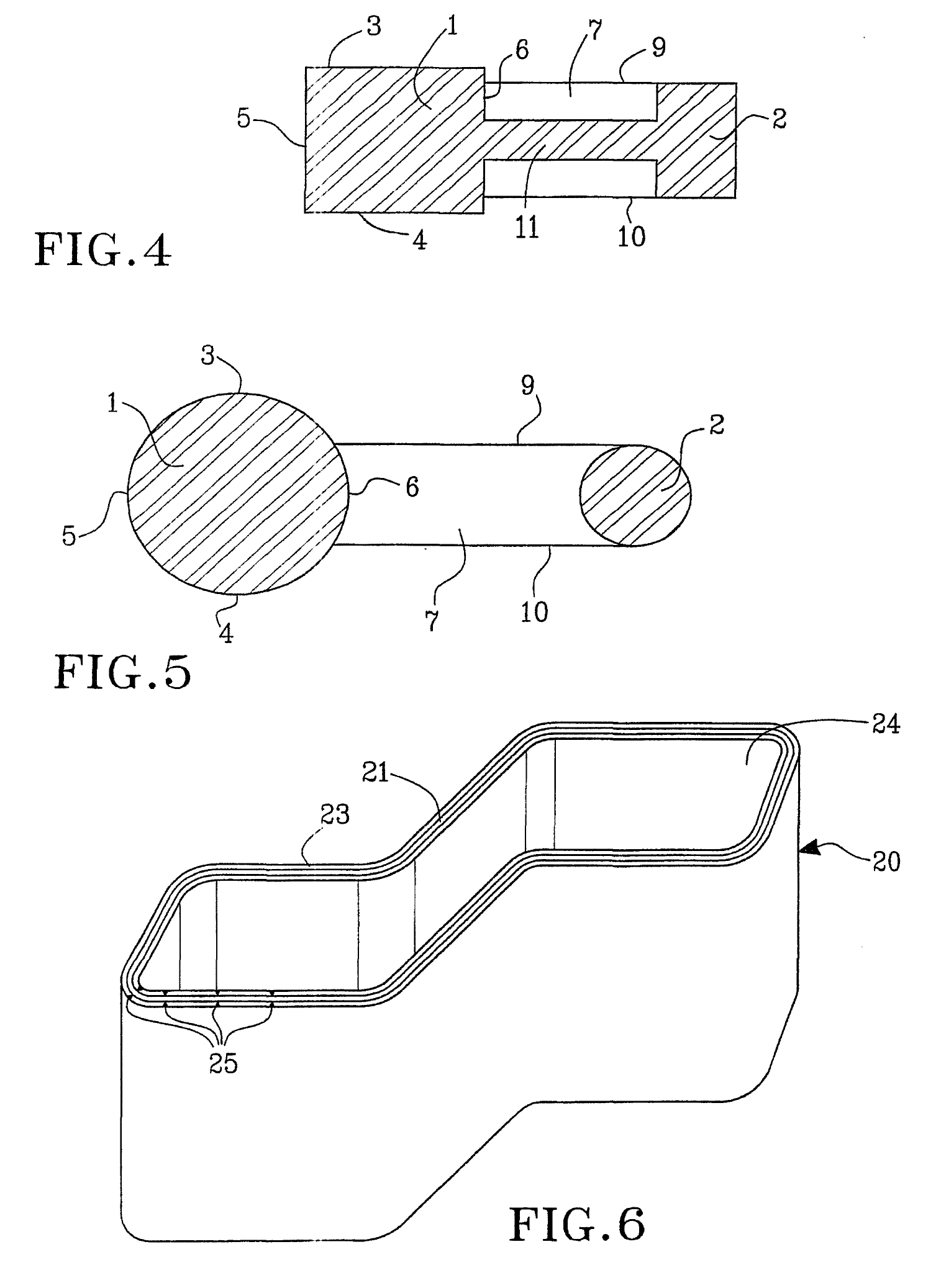

In the embodiment which is shown in FIG. 4, the recess forms a narrow waist 11 which connects the outside of the protrusion 2 with the sealing strip.

In order to enable the sealing strip 1 to rest flatly against the bottom surface in the groove where the sealing strip is to be applied, the sealing strip is arranged in such a way that a projection 9, 10 of the upper and lower delimitation surfaces 3, 4 of the protrusion in parallel with the width B of the sealing strip are located between the upper and lower delimitation surfaces of the sealing strip.

In the illustrated embodiments, the height Hᵤ of the protrusion is smaller than the height Hₗ of the sealing strip. Thereby, “width” and “height” refer to the extension in two directions orthogonal to the length coordinate of the sealing strip. The width coordinate, which in the attached figures is indicated by an arrow B, extends in parallel with the tangent of the lower delimitation surface at the portion which is intended to abut against the bottom surface of the groove into which the sealing strip is intended to be inserted. The height coordinate, indicated by an arrow H, is perpendicular to the length coordinate, indicated with an arrow X (see FIG. 1), and the width coordinate B.

In order to reduce the change of height of the sealing strip after pinching it into a groove, the protrusion preferably is designed with a height smaller than one-half of the sealing strip height, and more preferably, smaller than one-third of the sealing strip height. In other exemplary embodiments the volume of the protrusion is smaller than one-half of the volume of the strip from the beginning of the protrusion to the end of the protrusion. Thereby, “beginning” and “end” refers to those points where the outer side wall 12 of the protrusion abuts against the sealing strip. In still another preferred embodiment, the volume of the protrusion is smaller than one-third of the volume of the strip from the beginning of the protrusion to the end of the protrusion. Furthermore, the volume of the recess constitutes at least one-third of the total volume of the protrusion. Thereby, “volume of the protrusion” refers to the volume difference between a protrusion lacking the recess and the volume of a protrusion having a recess. Dimensions of a protrusion having no recess is created by assuming that the projection extends solidly from the sealing strip.

In a particularly preferred embodiment of the invention, which is exemplarily shown in FIG. 8, the upper delimitation surface 3 of the sealing strip, the lower delimitation surface 4, and portions of a side surface 6 of the sealing strip where the protrusion 2 is arranged, are designed with a continuous direction of the respective surface perpendiculars of these sides. In FIG. 8, these surface perpendiculars are denoted with n_{ö}, and nₛ. The direction of the surface perpendicular nᵤ of a side surface 12 of the protrusion 2, facing away from the sealing strip, changes direction so that the scalar product between the surface perpendicular of this outer side surface and a vector along the longitudinal direction of the sealing strip in this portion shifts sign on both sides of the recess in the longitudinal direction of the sealing strip. By means of this design, a continuous shape of the cross-section of the sealing strip is obtained at the protrusion, something which further reduces the occurrence of change in height when the protrusion is pinched into a groove.

In the preferred embodiment of FIG. 1, the protrusion 2 exhibits an outer side surface 12 facing away from the sealing strip, and an inner side surface 13 facing towards the sealing strip. The inner side surface is curved and exhibits a maximum radius of curvature Rᵢ. The outer side surface is curved and exhibits a maximum radius of curvature R_{y}. The maximum radius of curvature of the outer side surface is advantageously larger than the maximum radius of curvature of the inner side surface as illustrated.

It should also be appreciated that the sealing strip may also be designed as an endless strip.

FIG. 6 shows a first component part 20 of an arrangement and which is intended to be joined to a second component part, not shown, and to support a sealing strip 1 in accordance with the foregoing description in a groove 21. The groove 21 is applied along a surface 23 of the first component part 20, which surface surrounds an opening 24 of the first component part 20. In the embodiment shown in FIG. 6, the groove 21 is designed with a longitudinal direction which varies in three dimensions. This means that the groove is intended for a sealing strip having a longitudinal direction which varies in three dimensions.

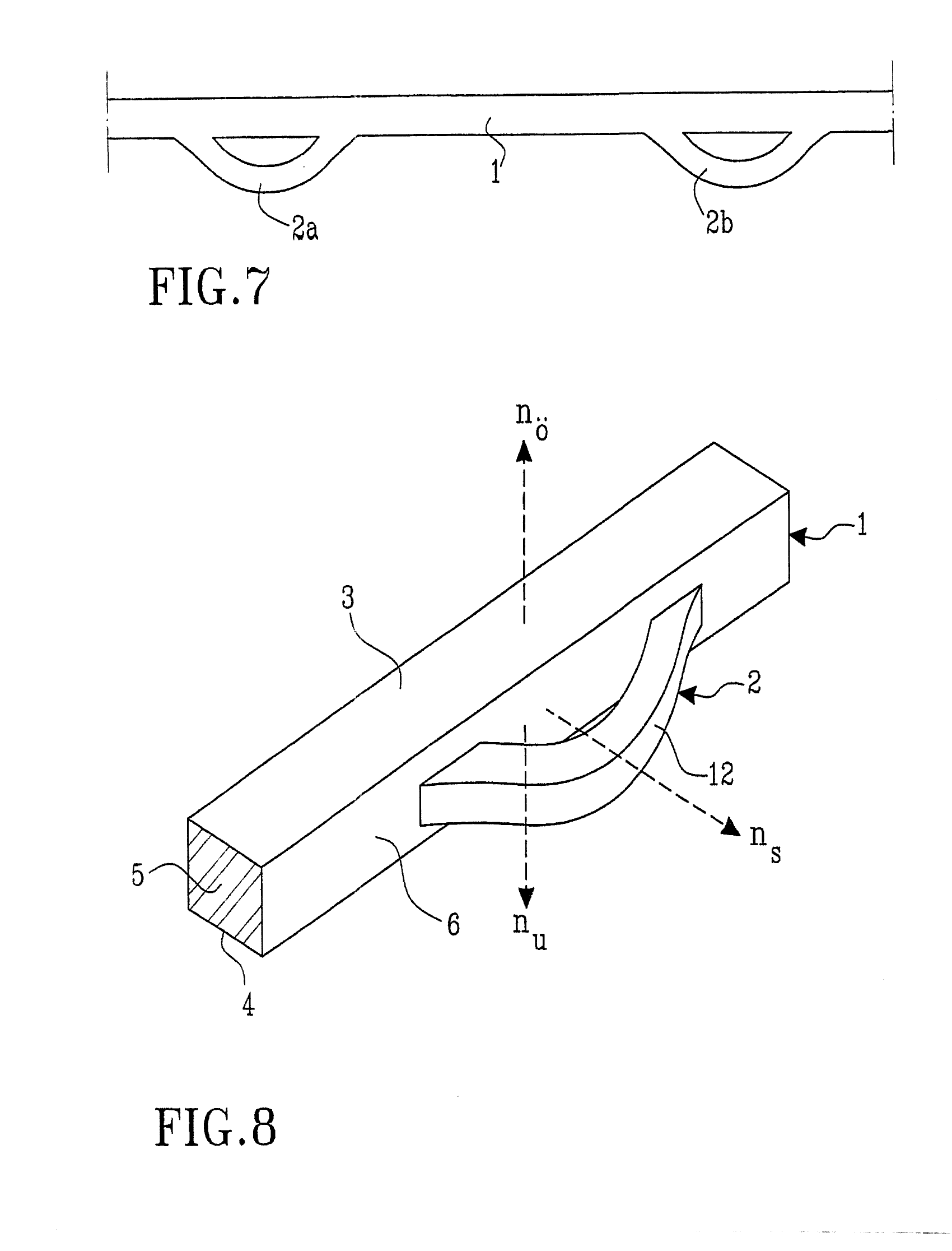

FIG. 7 shows a sealing strip 1 with two successive protrusions 2a, 2b. Preferably, the spacing and the design of these protrusions are designed in such a way that the sealing strip is installed in a self-supporting way when installed in a groove facing downwards. This means that the distance between two successive protrusions should be such that μ,*F>m*g, where μ is the coefficient of friction between seal and groove, F is the clamping force of the protrusion, m is the weight supported by a protrusion, and g is the acceleration due to gravity. For the weight m, it is true that m=ρ*A*l, where l=the length between two protrusions, A is the area of the sealing strip, and p is the density of the sealing strip.

In a preferred embodiment of the invention, markings 25 are provided along the groove 21 as illustrated in FIG. 6. These markings indicate where the protrusions are to be positioned. In this way, installation with a constant clamping force of the sealing strip along the groove is facilitated.

1. A sealing arrangement comprising:
a sealing strip made of a substantially incompressible material, for sealing between a first and a second component part which have been joined together, wherein the sealing strip is adapted to be inserted into a groove present on the first component part, and the sealing strip exhibits a substantially constant width along the main portion of its length and at least one protrusion on the sealing strip, wherein the sealing strip is intended to be pinched into said groove at this portion; and
said at least one protrusion exhibits a recess which is intended to be at least partially compressed by said pinching.

2. The sealing arrangement as recited in claim 1, further comprising:
said recess is designed as a lead-through.

3. The sealing arrangement as recited in claim 2, further comprising:
said sealing strip exhibits a lower delimitation surface intended to abut against a bottom surface formed in said groove, and an upper delimitation surface intended to abut against said second component part; and
the lead-through extends through the protrusion in a direction between said upper delimitation surface and lower delimitation surface.

4. The sealing arrangement as recited in claim 1, further comprising:
said protrusion exhibits an upper delimitation surface and a lower delimitation surface and a projection of the upper and lower delimitation surfaces of the protrusion in parallel with the width of the sealing strip are located between the upper and lower delimitation surfaces of the sealing strip.

5. The sealing arrangement as recited in claim 4, further comprising:
said protrusion exhibits an extension in height-direction which is smaller than the extension in height-direction of the sealing strip.

6. The sealing arrangement as recited in claim 1, further comprising:
said upper delimitation surface of the sealing strip, the lower delimitation surface, and portions of a side surface of the sealing strip where the protrusion is arranged, are designed with the surface perpendiculars of these surfaces in a continuous direction, whereas the direction of the surface perpendicular of an outer side surface of the protrusion facing away from the sealing strip changes direction so that the scalar product between the surface perpendicular of this outer side surface and a vector along the longitudinal direction of the sealing strip in this portion shifts sign on both sides of the recess in the longitudinal direction of the sealing strip.

7. The sealing arrangement as recited in claim 1, further comprising:
said protrusion exhibits an outer side surface facing away from the sealing strip, and an inner side surface facing towards the sealing strip, that the inner side surface is curved and exhibits a maximum radius of curvature Rᵢ, and that the outer side surface is curved and exhibits a maximum radius of curvature R_{y}, wherein the maximum radius of curvature of the outer side surface is larger than the maximum radius of curvature of the inner side surface.

8. The sealing arrangement as recited in claim 1, further comprising:
said sealing strip is designed as an endless strip.

9. The sealing arrangement as recited in claim 1, further comprising:
said sealing strip is designed with a longitudinal direction which varies in three dimensions.

10. A component comprising a first component part and a second component part, and a sealing strip which is designed to be inserted into a groove being present on the first component part, wherein the sealing strip exhibits a substantially constant width along the main portion of its length, and the sealing strip at this portion is intended to be pinched into said groove, and said at least one protrusion exhibits a recess which is intended to be at least partially compressed by said pinching.

11. The component as recited in claim 10, further comprising:
said recess is designed as a lead-through.

12. The component as recited in claim 10, further comprising:
said sealing strip exhibits a lower delimitation surface intended to abut against a bottom surface formed in the groove, and an upper delimitation surface intended to abut against said second component part; and
the lead-through extends between said upper delimitation surface and lower delimitation surface.

13. The component as recited in claim 10, further comprising:
said protrusion exhibits an upper delimitation surface and a lower delimitation surface; and
a projection of the upper and lower delimitation surfaces of the protrusion in parallel with the width of the sealing strip are located between the upper and the lower delimitation surfaces of the protrusion.

14. The component as recited in claim 10, further comprising:
said protrusion exhibits an extension in height-direction which is smaller than the extension in height-direction of the sealing strip.

15. The component as recited in claim 10, further comprising:
said upper delimitation surface of the sealing strip, the lower delimitation surface, and portions of a side surface of the sealing strip where the protrusion is arranged, are designed with a continuous direction of the surface perpendiculars of these surfaces, whereas the direction of the surface perpendicular of a side surface of the protrusion, facing away from the sealing strip, changes direction so that the scalar product between the surface perpendicular of this outer side surface and a vector along the longitudinal direction of the sealing strip in this portion shifts sign on both sides of the recess in the longitudinal direction of the sealing strip.

16. The component as recited in claim 10, further comprising:
said protrusion exhibits an outer side surface facing away from the sealing strip and an inner side surface facing towards the sealing strip, that the inner side surface is curved and exhibits a maximum radius of curvature Ri and that the outer side surface is curved and exhibits a maximum radius of curvature Ry, wherein the maximum radius of curvature of the outer side surface is larger that the maximum radius of curvature of the inner side surface.

17. The component as recited in claim 10, further comprising:
said sealing strip is designed with a sufficient number of protrusions in order to enable self-supporting installation in the groove.

18. The component as recited in claim 10, further comprising:
said groove and the sealing strip are designed in an endless way.

19. The component as recited in claim 10, further comprising:
said sealing strip and the groove are designed with a longitudinal direction varying in three dimensions.
